(19) United States
(12) Patent Application Publication
(10) Pub. No.: US 2009/0278866 A1
(43) Pub. Date: Nov. 12, 2009

(54) Gamma corrected display device

(76) Inventor: Jong-Soo Kim, Yongin-city (KR)

Correspondence Address: LEE & MORSE, P.C., 3141 FAIRVIEW PARK DRIVE, SUITE 500, FALLS CHURCH, VA, 22042, US

(21) Appl. No.: 12/453,140

(22) Filed: Apr. 30, 2009

(30) Foreign Application Priority Data
May 8, 2008 (KR) 10-2008-0042667

(51) Int. Cl. G09G 5/10; G06F 3/038

(52) U.S. Cl. 345/690; 345/213

(57) ABSTRACT

A display device includes a pixel unit including a plurality of pixels, a data driver adapted to supply data signals to the pixels, and a timing controller adapted to supply data control signals and image data to the data driver, wherein the timing controller is adapted to divide the pixel unit into a plurality of regions and supply gamma values assigned to each region to the data driver.

### BACKGROUND OF THE INVENTION

1. Field of the Invention

Embodiments relate to a display device. More particularly, embodiments relate to a gamma corrected display device capable of displaying a uniform image.

2. Description of the Related Art

Recently, various flat panel display devices that are lighter weight and occupy less volume than a cathode ray tube have been developed. Among the flat panel display devices, an organic light emitting display device uses organic compounds as light emitting material. Organic light emitting display devices provide excellent brightness and color purity and have been spotlighted as a next generation display device.

Such an organic light emitting display device emits light at a brightness corresponding to pixel power supplied to a pixel and data signals. For example, each pixel of an active-type organic light emitting display device driven in a voltage driving manner emits light at a brightness corresponding to a voltage difference between pixel power supplied and data signals.

Therefore, in order to display a uniform image corresponding to the data signals, uniform pixel power and data signals need to be supplied to pixels. However, since the pixel power and the data signals are supplied to the pixels through wires, voltage variations between the pixel power and the data signals may occur according to positions of the pixels, i.e., due to an increased wire length. Such voltage variations increase as a display panel size increases.

In other words, in a general organic light emitting display device, different positions of the pixels result in different wire loads, which may result in non-uniform brightness and color purity.

### SUMMARY OF THE INVENTION

Embodiments are therefore directed to a display device, which substantially overcomes one or more of the problems associated with the related art.

It is a feature of an embodiment to provide a gamma corrected display device capable of a more uniform image.

At least one of the above and other features and advantages may be realized by providing an organic light emitting display device including a pixel unit including a plurality of pixels, a data driver adapted to supply data signals to the plurality of pixels, and a timing controller adapted to supply data control signals and image data to the data driver, the timing controller adapted to divide the pixel unit into a plurality of regions and supply gamma values assigned to each region to the data driver.

The timing controller may include a counter adapted to count synchronization signals and output counting signals corresponding thereto, a plurality of lookup tables adapted to store different gamma values, and a controller adapted to divide the pixel unit into a plurality of regions corresponding to the counting signals and to map any one of the plurality of lookup tables for each region to output the image data and assign a corresponding gamma value.

The counter may be adapted to count horizontal synchronization signals. The controller may be adapted to determine a number of rows of the pixel unit by the counting signals and divide the pixel unit into a plurality of regions according to the number of rows of the pixel unit and a number of lookup tables. Each region may include a substantially equal number of rows.

The timing controller may be adapted to divide the pixel unit into a plurality of regions according to a distance between the region and the data driver and assign a larger gamma value to the region as the distance increases.

The data driver may be adapted to generate the data signals within each region according to an assigned gamma value.

The data driver may include a first data driver and a second data driver on opposite sides of the pixel unit. The timing controller may be adapted to divide the pixel unit into regions in a direction from a central region of the pixel to the first and second data drivers, and assign the gamma values to be symmetrical relative to the central region of the pixel unit.

The display device may include a plurality of lookup tables adapted to store different gamma values, and the timing controller may be adapted to divide the pixel unit into a plurality of regions according to a number of rows of the pixel unit and a number of lookup tables. Each region may include a substantially equal number of rows.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an organic light emitting display device according to one embodiment of the present invention;

FIG. 2 illustrates one example of the timing controller of FIG. 1;

FIG. 3 illustrates a pixel unit to which different gamma values are assigned by the timing controller of FIG. 2;

FIG. 4 illustrates another example of the timing controller of FIG. 1;

FIG. 5 illustrates a pixel unit to which different gamma values are assigned by the timing controller of FIG. 4;

FIG. 6 illustrates an organic light emitting display device according to another embodiment of the present invention; and

FIG. 7 illustrates a pixel unit to which different gamma values are assigned by the timing controller of FIG. 6.

### DETAILED DESCRIPTION OF THE INVENTION

Korean Patent Application No. 10-2008-0042667, filed on May 8, 2008, in the Korean Intellectual Property Office, and entitled: “Organic Light Emitting Display Device,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “connected to” another element, it can be directly connected to the element or be indirectly connected to the element with one or more intervening elements interposed therebetween. Hereinafter, like reference numerals refer to like elements.

As discussed in detail below, a pixel unit may be divided into a plurality of regions based on a distance from a data driver, and data signals supplied to each of the regions may be compensated using different gamma values. As such, a more uniform image may be displayed.

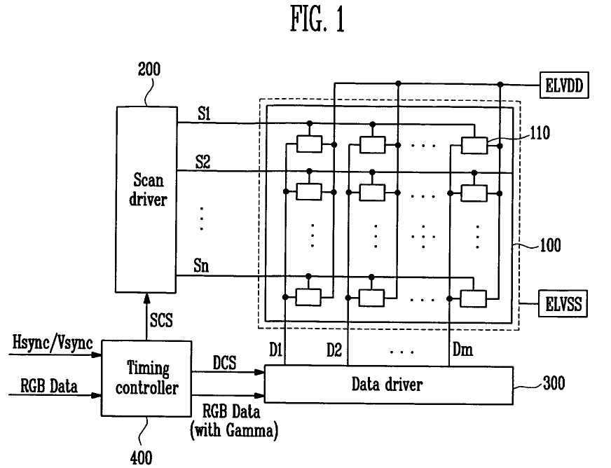

FIG. 1 illustrates an organic light emitting display device according to one embodiment of the present invention. Referring to FIG. 1, an organic light emitting display device according to one embodiment of the present invention may include a pixel unit 100, a scan driver 200, a data driver 300, and a timing controller 400.

The pixel unit 100 may include a plurality of pixels 110 at an intersection portion of scan lines S1 to Sn and data lines D1 to Dm. The pixels 110 may receive scan signals and data signals from the scan lines S1 to Sn and data lines D1 to Dm, respectively, and receive first and second pixel power ELVDD and ELVSS from a power supplier (not shown), etc. Such pixels 110 emit light corresponding to the scan signals, the data signals, and the first and second pixel power ELVDD and ELVSS, thereby displaying an image.

The scan driver 200 may sequentially generate the scan signals corresponding to scan control signals SCS supplied from the timing controller 400. The scan control signals SCS may include start pulses and clock signals, etc. The scan driver 200 may supply the generated scan signals to the pixels 110 through the scan lines S1 to Sn.

The data driver 300 may generate data corresponding to data control signals DCS supplied from the timing controller 400 and image data RGB Data. The data control signals DCS may include data enable signals, clock signals, etc. The image data RGB Data may have a predetermined gamma value applied thereto by the timing controller 400. In other words, the data driver 300 may generate the data signals by applying the gamma value to the image data RGB Data, i.e., the data signals may be adjusted in accordance with the predetermined gamma value. The data driver 300 may supply the generated data signals to the pixels 110 through the data lines D1 to Dm.

The timing controller 400 may receive the synchronization signals and image data RGB Data from an external source, e.g., a host, etc. The synchronization signals may include horizontal synchronization signals Hsync, vertical synchronization signals Vsync, and/or data enable signals, etc. The timing controller 400 may generate the scan control signals SCS and the data control signals DCS corresponding to the synchronization signals, and supply them to the scan driver 200 and the data driver 300, respectively. The timing controller 400 may process the image data RGB Data and supply the image data RGB and gamma values to the data driver 300.

In embodiments, the timing controller 400 may divide the pixel unit 100 into a plurality of regions to assign gamma values for each region, thereby supplying the image data RGB Data appointed with the gamma values to the data driver 300.

For example, the timing controller 400 may divide the pixel unit 100 into a plurality of regions according to the distance between a region and the data driver 300. For regions further from the data driver 300, the image data RGB Data may be assigned larger gamma values.

In other words, in order to compensate for non-uniformity of an image when non-uniform pixel power ELVDD/ELVSS and/or data signals are supplied to the pixels 110 due to IR drop generated along wires supplying the signals, the timing controller 400 may control the gamma values to be differently applied per region of the pixel unit 100.

The data driver 300 may convert the image data RGB Data according to the gamma values assigned by the timing controller 400 to generate the data signals. In other words, the data signals generated from the data driver 300 may be differently adjusted for each region of the pixel unit 100 to be supplied to the pixels 110.

As described above, embodiments may divide the pixel unit 100 into a plurality of regions and supply the data signals to which gamma values are differently applied per each region thereto, reducing or eliminating non-uniformity in a displayed image.

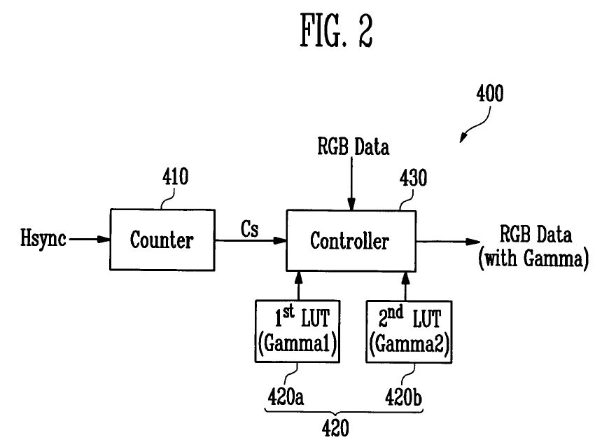

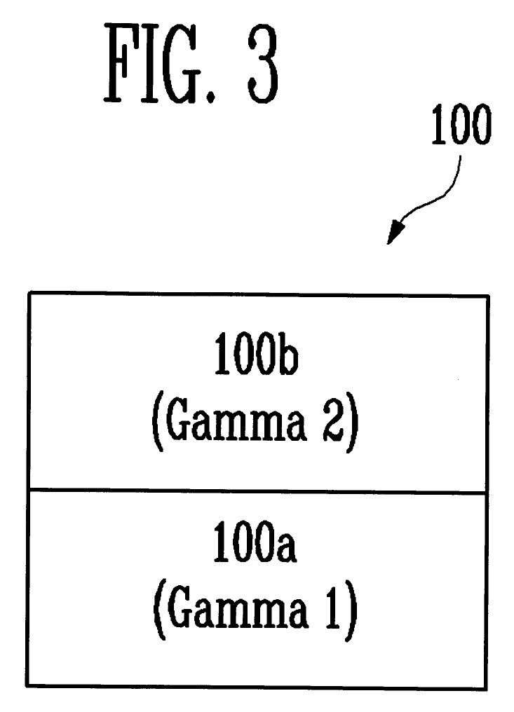

FIG. 2 illustrates one example of the timing controller 400 of FIG. 1. FIG. 3 illustrates a pixel unit to which different gamma values are assigned by the timing controller of FIG. 2.

Referring to FIGS. 2 and 3, the timing controller 400 may include a counter 410, first and second lookup tables (hereinafter, referred to as LUT) 420a, 420b, and a controller 430.

The counter 410 may count synchronization signals supplied from the external and output counting signals Cs corresponding thereto to the controller 430. For example, the counter 410 may count horizontal synchronization signals Hsync supplied from a host and output counting signals Cs corresponding thereto. The signals counted by the counter 410 are not limited to the horizontal synchronization signals Hsync. For example, the counter 410 may count data enable signals and/or the number of scan lines S.

The first and second LUTs 420a and 420b may store gamma values (or gamma curves) each different per gray scale. For example, the first LUT 420a may store a first gamma value Gamma1 per gray scale and the second LUT 420b may store a second gamma value Gamma2 per gray scale.

The controller 430 may divide the pixel unit 100 into a plurality of regions to which different gamma values each assigned in accordance with the counting signals Cs from the counter 410. In other words, the controller 430 may determine the number of rows in the pixel unit 100 from the counting signals Cs and may divide the pixel unit 100 into a plurality of regions according to the number of rows of the pixel unit 100 and the number of LUT 420. For example, each LUT 420 may be assigned to a same number of rows.

For example, as shown in FIG. 2, when two LUTs 420, i.e., first and second LUTs 420a and 420b, are provided, the controller 430 may divide the pixel unit 100 into first and second regions 100a and 100b in a row unit. The controller 430 may map the respective first and second LUT 420a, 420b in the first and second regions 100a and 100b. Thereby, the controller 430 may assign and output the first gamma value Gamma1 to the image data RGB Data to be displayed in the first region 100a, and may assign and output the second gamma value Gamma2 to the image data RGB Data to be displayed in the second region 100b. A region further from the data driver 300 may be assigned a larger gamma value than that assigned to a closer region, allowing for compensation of brightness and distortion of color coordinates.

FIGS. 2 and 3 illustrate the case where two LUTs 420a and 420b storing different two gamma values Gamma1 and Gamma2 are provided, and the pixel unit 100 is divided into two regions 100a and 100b. However, embodiments are not limited thereto. In other words, in embodiments, the pixel unit 100 may be divided into a plurality of regions and the data signals displayed in each region may be corrected using a plurality of gamma values so that the organic light emitting display device displays a more uniform image, as discussed below.

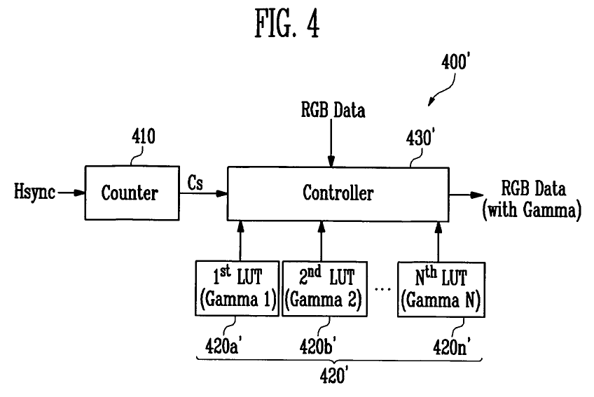

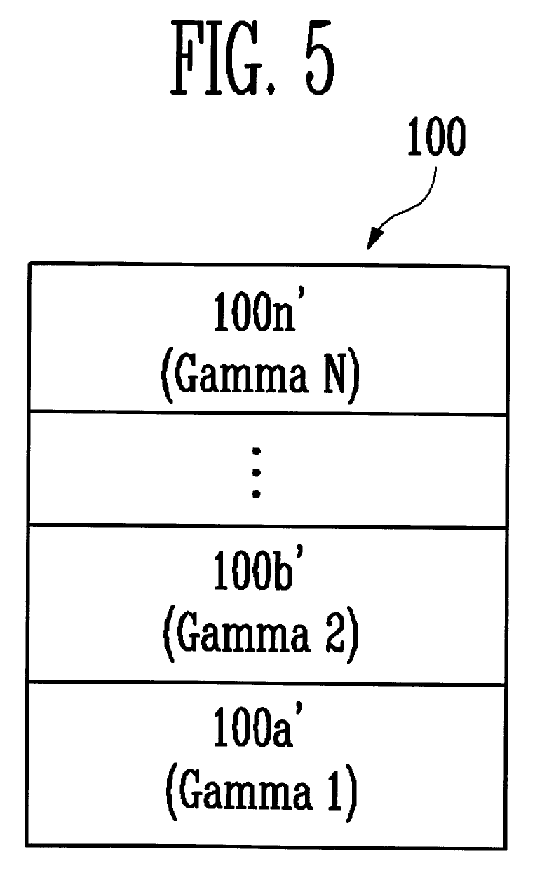

FIG. 4 illustrates another example of the timing controller of FIG. 1. FIG. 5 illustrates a pixel unit to which different gamma values are assigned by the timing controller of FIG. 4.

Referring to FIGS. 4 and 5, a timing controller 400′ may include first to nth LUT 420′ to 420n′ each storing first to nth gamma values Gamma1 to GammaN. As shown in FIG. 5, the controller 430′ may divide the region of the pixel unit 100 into first to nth regions 100a′ to 100n′ to allow the different first to nth gamma values to be assigned per region, respectively.

In other words, in FIGS. 4 and 5, the pixel unit 100 may be divided into three or more regions 100a′ to 100n′, and different values may be applied to the respective regions 100a′ to 100n′ using three or more gamma values Gamm1 to GammaN. Thereby, non-uniformity of image quality may be reduced or prevented. In this manner, embodiments may provide an organic light emitting display device displaying a more uniform image, even when a display panel becomes large.

The aforementioned embodiment with reference to FIGS. 4 to 5 operates on the same principles as that of FIGS. 2 and 3 expanded to apply to three or more regions. Thus, the detailed description will not be repeated.

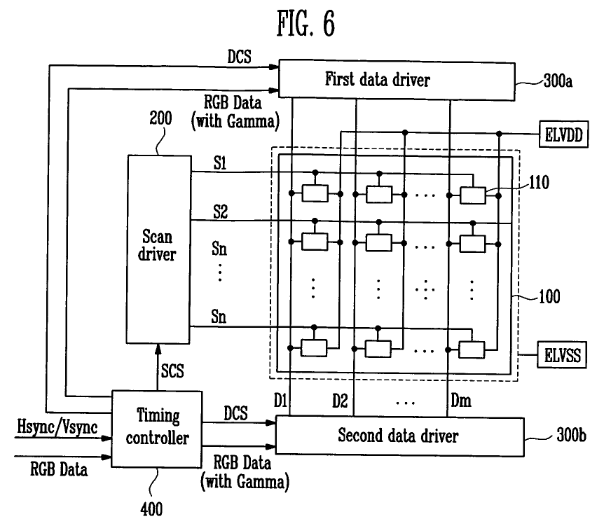

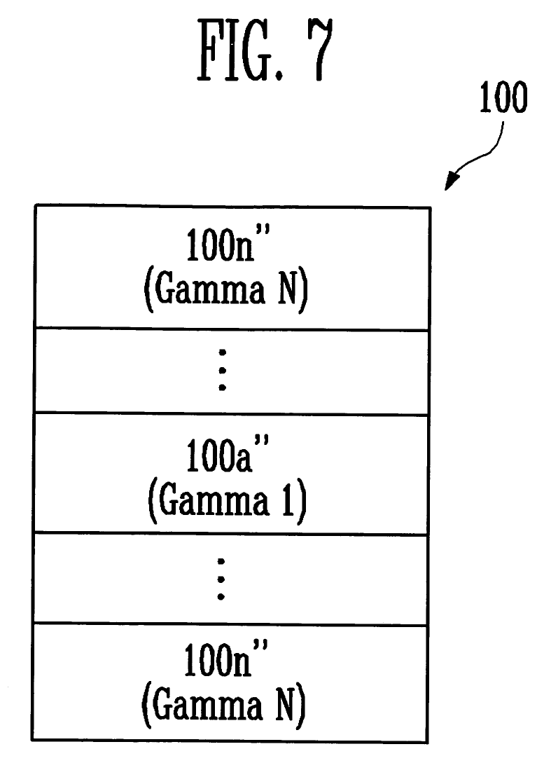

FIG. 6 illustrates an organic light emitting display device according to another embodiment of the present invention. FIG. 7 illustrates different gamma values to be assigned to regions of the pixel unit of FIG. 6. FIGS. 6 and 7 illustrate an embodiment where a plurality of data drivers are provided on different sides of a pixel unit, wherein the same reference numerals will be used for the same elements discussed above with reference to aforementioned FIGS. 1 to 5, and the detailed description thereon will not be repeated.

Referring to FIGS. 6 and 7, first and second data drivers 300a, 300b may each be provided on two sides, e.g., an upper side and a lower side, of the pixel unit 100, these sides being opposed to each other. In other words, the pixel unit 100 may simultaneously receive data signals from two sides.

As described above, when the pixel unit 100 simultaneously receives the data signals from the both sides, the pixel unit 100 may be divided into a plurality of regions 100a″ to 100n″ symmetrical to each other about a central region 100a″ relative to the respective first and second data drivers 300a, 300b. In other words, the distance between regions of the pixel unit 100 and the data drivers 300a, 300b may be approximately symmetrical relative to the central region 100a″ of the pixel unit 100. Therefore, the timing controller 400 may be constituted as shown in FIG. 2 or FIG. 4 to symmetrically appoint gamma values Gamm1 to GammaN based on the central region 100a″ of the pixel unit 100, displaying a more uniform image on the pixel unit 100. Again, the different gamma values may increase the further the region is located from the respective data drivers 300a, 300b.

Although FIGS. 1 to 7 describe only the organic light emitting display device by way of example, embodiments are not limited thereto, but embodiments may be applied to various types of display devices. Also, in the aforementioned embodiments, the scan driver and the data driver are described as separate components. However, the drivers may be integrated on a driving IC mounted on one integrated circuit chip.

According to embodiments above, the timing controller may assign different gamma values to data signals for different regions of the pixel unit. Thus, an image may be made more uniform without requiring a change in design of components, e.g., a data driver. Therefore, embodiments may readily compensate for pixel power generated via wires and/or voltage drop of the data signals, allowing a more uniform image to be displayed.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
a pixel unit including a plurality of pixels;
a data driver adapted to supply data signals to the plurality of pixels; and
a timing controller adapted to supply data control signals and image data to the data driver,
the timing controller being adapted to divide the pixel unit into a plurality of regions and to supply gamma values assigned to each region to the data driver.

2. The display device as claimed in claim 1, wherein the timing controller comprises:
a counter adapted to count synchronization signals and output counting signals corresponding thereto;
a plurality of lookup tables adapted to store different gamma values; and
a controller adapted to divide the pixel unit into a plurality of regions, corresponding to the counting signals and to map any one of the plurality of lookup tables for each region to output the image data and assign a corresponding gamma value.

3. The display device as claimed in claim 2, wherein the counter is adapted to count horizontal synchronization signals.

4. The display device as claimed in claim 2, wherein the controller is adapted to determine a number of rows of the pixel unit by the counting signals and divide the pixel unit into a plurality of regions according to the number of rows of the pixel unit and a number of lookup tables.

5. The display device as claimed in claim 4, wherein each region includes a substantially equal number of rows.

6. The display device as claimed in claim 1, wherein the timing controller is adapted to divide the pixel unit into a plurality of regions according to a distance between the region and the data driver and to assign a larger gamma value to the region as the distance increases.

7. The display device as claimed in claim 1, wherein the data driver is adapted to generate the data signals within each region according to an assigned gamma value.

8. The display device as claimed in claim 1, wherein the data driver includes a first data driver and a second data driver on opposite sides of the pixel unit.

9. The display device as claimed in claim 7, wherein the timing controller is adapted to divide the pixel unit into regions in a direction from a central region of the pixel to the first and second data drivers and to assign the gamma values to be symmetrical relative to the central region of the pixel unit.

10. The display device as claimed in claim 1, further comprising a plurality of lookup tables adapted to store different gamma values, wherein the timing controller is adapted to divide the pixel unit into a plurality of regions according to a number of rows of the pixel unit and a number of lookup tables.

11. The display device as claimed in claim 10, wherein each region includes a substantially equal number of rows.

12. The display device as claimed in claim 1, wherein each pixel in the pixel unit includes organic light emitting material.
